(19) United States
(12) Patent Application Publication
(10) Pub. No.: US 2013/0326576 A1
(43) Pub. Date: Dec. 5, 2013

(54) METHOD AND DEVICE FOR VIEW SWITCHING

(71) Applicants: Zhigang Zhang, Beijing (CN); Linxiang Cheng, Beijing (CN); Xiaojun Ma, Beijing (CN)

(72) Inventors: Zhigang Zhang, Beijing (CN); Linxiang Cheng, Beijing (CN); Xiaojun Ma, Beijing (CN)

(73) Assignee: THOMSON LICENSING, Issy de Moulineaux (FR)

(21) Appl. No.: 13/985,409

(22) PCT Filed: Feb. 28, 2011
(86) PCT No.: PCT/CN11/00317

§ 371 Date: Aug. 14, 2013

(51) Int. Cl. H04N 21/41

(52) U.S. Cl. CPC H04N 21/4113
USPC 725/133

(57) ABSTRACT

It is provided a method for view switching between a first device and a second device. The first device and the second device are used to display respectively a first multimedia content and a second multimedia content that are correlated, it comprises the steps of receiving and displaying, by the first device, data of the first multimedia content; in response to a view switching instruction, sending data of the first multimedia content to the second device and receiving data of the second multimedia content from the second device; and displaying the received data of the second multimedia content.

### TECHNICAL FIELD

The present invention relates to multimedia, and more particularly relates to a method and a device for view switching.

### BACKGROUND

Many known art describes the handover of content playback from a first device to a second device. For example, the patent application US2008/0177822 describes a content playback method. The method comprises the following steps. A first playback device, upon receiving a synchronized playback command while content playback is in progress, transmits, to a second playback device, information that pertains to the playback content and a synchronized playback start time obtained by adding a predetermined additional time to an elapsed playback time for the content. The second playback device starts receiving content data that begins from the synchronized playback start time from a server. After the data that is memorized in a memory reaches a specified volume, the second playback device transmits a playback preparation completion notification to the first playback device. Once the elapsed playback time for the content reaches the synchronized playback start time, the first playback device transmits a playback start command to the second playback device. Upon receiving this command, the second playback device starts playing back content data that begins from the synchronized playback start time.

### SUMMARY

According to an aspect of present invention, it is provided a method for view switching between a first device and a second device. The first device and the second device are used to display respectively a first multimedia content and a second multimedia content that are correlated, it comprises the steps of receiving and displaying, by the first device, data of the first multimedia content; in response to a view switching instruction, sending data of the first multimedia content to the second device and receiving data of the second multimedia content from the second device; and displaying the received data of the second multimedia content.

According to another aspect of present invention, it is provide first device for viewing change between it and a second device, wherein the first device and the second device are used to display a first multimedia content and a second multimedia content that are correlated, it comprises a streaming center configured to send and receive data; and a transcoder configured to decode the data of the first multimedia content for displaying, wherein, in response to a view switching instruction, the transcoder provides the data of the first multimedia content to the streaming center to send to the second device and receives data of the second multimedia content via the streaming center from the second device.

According to the aspect of present invention, it allows view change between two devices.

It is to be understood that more aspects and advantages of the invention will be found in the following detailed description of the present invention.

### BRIEF DESCRIPTION OF THE DRAWINGS

The accompanying drawings, which are included to provide a further understanding of the, illustrate embodiments of the invention together with the description which serves to explain the principle of the invention. Therefore, the invention is not limited to the embodiments. In the drawings:

FIG. 1 is a block diagram showing an example of system architecture according to an embodiment of present invention;

FIG. 2 is a diagram showing an example of the control interface on the TV screen according to the embodiment;

FIG. 3 is a flow chart showing a method for view switching according to the embodiment.

### DETAILED DESCRIPTION

An embodiment of the present invention will now be described in detail in conjunction with the drawings. In the following description, some detailed descriptions of known functions and configurations may be omitted for clarity and conciseness.

Multimedia is media or content that uses a combination of different content forms including text, audio, still image, animation, video, and interactivity content forms. Nowadays, more and more homes are going to have two or more collaborative display devices, such as a TV (some may need to connect to a Set Top Box) and a tablet. The tablet comprises at least a processor, a display screen, an input device (e.g. touch screen), and a wired and/or wireless network interface. The STB and the tablet are connected in the home network. So two pieces of correlated content, e.g. a TV program and its corresponding information, can be displayed on the TV and the tablet respectively. The corresponding information includes advertisement of goods in the TV program in text form, image form, video form or a mix of them.

In addition, the STB and the tablet can be used to play any two views of a multi-view content. A multi-view content contains two or more views correlated to a same scene. These views are normally captured by the same number of cameras placed in different positions towards a same scene. The views captured by these cameras are usually called solid views. Sometimes, virtual views can be derived from the solid views. For example, the TV displays overall view of a football match, and the tablet displays zooming-in view of a particular football player.

The invention provides a method allowing a view change between the two devices during the content playback on both devices.

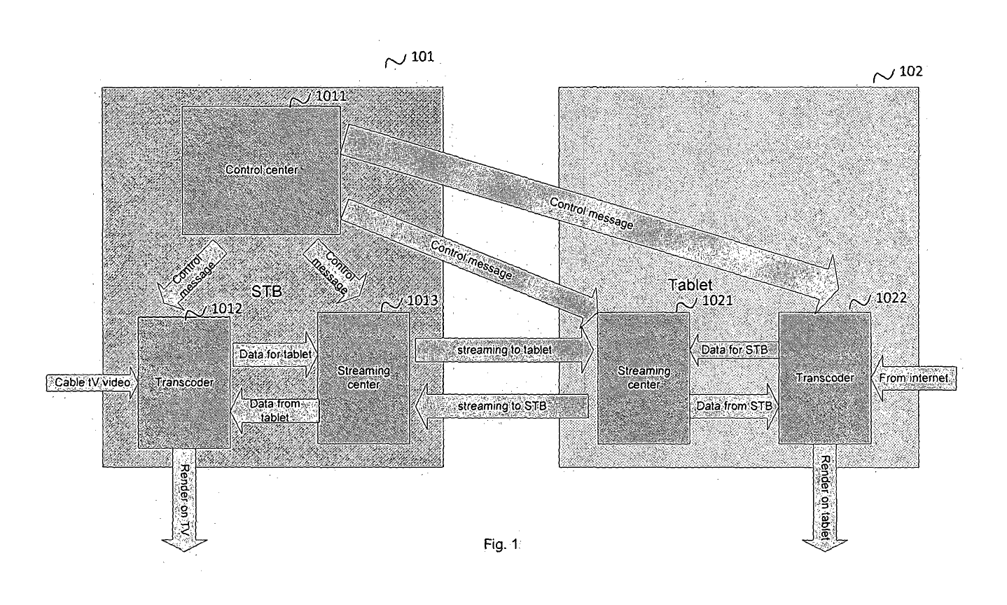

FIG. 1 is a block diagram showing an example of system architecture according to an embodiment of present invention. The system of this example comprises a STB 101 and a tablet 102. The STB 101 comprises a transcoder 1012, a streaming center 1013 and a control center 1011. The tablet 102 comprises a streaming center 1021 and a transcoder 1022.

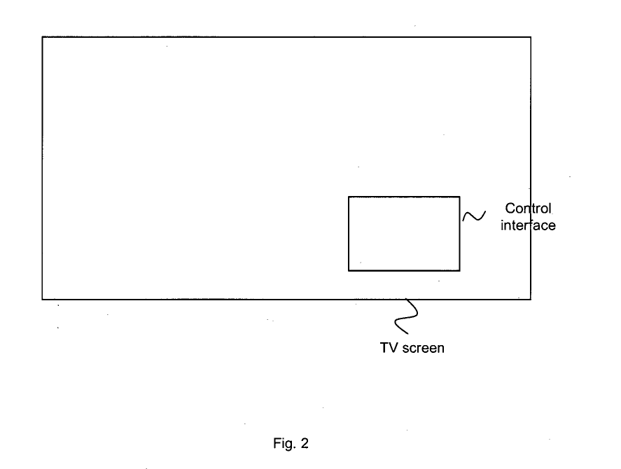

In the STB 101, modules function as follow.
the transcoder 1012 is configured to decode the content data of cable TV video, which is received from TV video server via a cable network, and provide the decoded data for the TV to render or display. In addition, the transcoder 1012 can transcode the video content from one video format to another. In this example, the transcoder 1012 is used to transcode the content of the cable TV video to a format that fits for the tablet to render, and to transcode the content of a video received from the tablet to a format fitting with the TV to render. The format comprises codec and resolution.
the streaming center 1013 includes functionalities of both streaming server and client, and is configured to stream data, send and receive streamed data. The counterpart of the streaming center 1013 in the tablet 102 is the streaming center 1021.
the control center 1011 is configured to provide control messages to transcoder 1012 and streaming center 1013 of the STB 101 and streaming center 1021 and transcoder 1022 of the tablet 102. It renders a control interface on the TV screen to allow a user to change views between the STB 101 and the tablet 102. The control interface can be an overlapping window at the bottom-right of the TV screen as shown by the FIG. 2. It shall note the overlapping window can also be placed in other positions, or in other forms. The overlapping window appears in response to user's pressing a view change button on a remote control. According to a variant, there is no overlapping window appearing on the TV. The views on both devices are interchanged immediately after the user presses the view change button on the remote control. In addition, the control center 1011 can acquire the format requirements (including information about codec and screen resolution) of both the STB 101 and the tablet 102. The format requirements are acquired in one of following ways: the control center 1011 stores the format requirements of both the STB 101 and the tablet 102 in advance, or queries the STB and the tablet, which store their format requirements respectively, for such requirements when necessary. Upon the command of view change, the control center 1011 sends messages 1) to transcoder 1012 of the STB 101 to decode data from the streaming center 1013 and transcode the content of the cable TV video to a format fitting for the tablet to render, 2) to streaming center 1013 to send data transcoded by the transcoder 1012 to its counterpart streaming center 1021 and receive data from the streaming center 1021, 3) to the transcoder 1022 of the tablet 102 to decode data from the streaming center 1021, and 4) to the streaming center 1021 to send data to its counterpart 1013 and receive data from it.

In the tablet 102, modules function as follow.
the transcoder 1022 is configured to decode the content of a video correlated to the cable TV video. For example, the video correlated to the cable TV video is another view of a multi-view content to which the cable TV video belongs, or it is an advertisement video correlated to the cable TV video. The video correlated to the cable TV video can be retrieved from a local storage or from Internet via IP network.
the streaming center 1022 includes functionalities of both streaming server and client, and is configured to stream data, send and receive streamed data.

In the above example, the invention puts the control center on the STB side because the STB has a stronger processing ability compared with the tablet. However, if the processing ability of the tablet is sufficient, it is possible to move the functionality of control center to the tablet side. In addition, the trancoding of video content for the purpose of suitable for the TV to render can be moved from the transcoder 1012 of the STB 101 to the transcoder 1022 of the tablet 102. Further, according to a variant of present embodiment, the control center can be moved to a dedicated device other than the STB and the tablet.

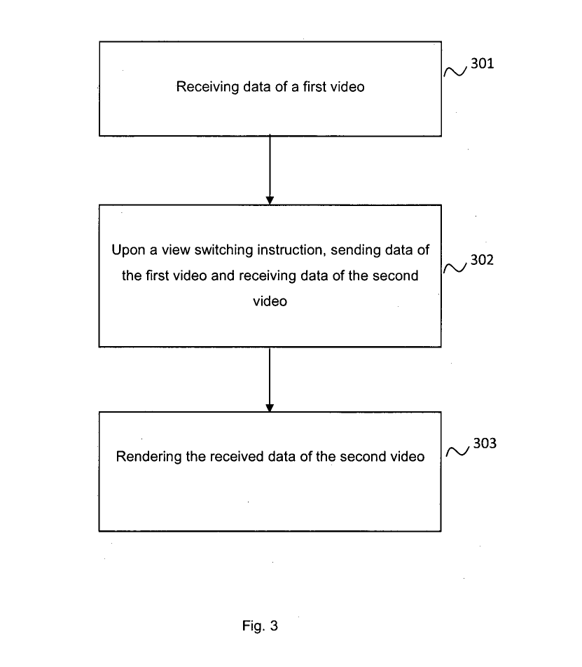

FIG. 3 is a flow chart illustrating a method for view switching according the embodiment of present invention. The method comprises the following steps.

Step 301, the STB receives data of a first video or a first view in a first format from a first server, e.g. a video program from TV server via cable network. And meanwhile, the tablet receives data of a second video or a second view in a second format from a second server, e.g. another video from Internet via IP network. The first video and the second video are correlated in terms of content, e.g. they are two views of a multi-view content. Herein, the first format and the second format are suitable for rendering on the TV and the tablet respectively.

Step 302, the user sends a view switching instruction by pressing a button on the remote control. In response to the view switching instruction, the STB sends the data of the first video in the second format to the tablet and receives data of the second video in the second format from the tablet. Meanwhile, the tablet receives data of the first video from the STB in the second format and sends data of the second video in the second format to the STB. Herein, before the STB sends the data of the first video, it needs to convert or transcode the data of the first video from the first format to the second format. The detailed steps for the format conversion include the control center 1011 determines the format suitable for the tablet, i.e. the second format, the control center 1011 sends a control message including the information about the second format to inform the transcoder 1012 of format to be converted, and the transcoder 1012 performs the conversion from the first format to the second format. Regarding the transmission of the data of the first video, the streaming center 1013 of the STB functions as a streaming server, and the streaming center 1021 of the tablet functions as a streaming client. At the beginning, the streaming server sends a message to the client on the tablet to ask the client to initiate the streaming. For the streaming in the direction from the STB to the tablet, the streaming process is synchronous, that is, the streaming process is performed at the same time of the rendering process because the data of the first video is gotten from cable TV channel in real time. When receiving the real time streaming from STB, the tablet will show the data of the first video in real time. Because the conversion of format and data transmission from the STB to the tablet takes time, the playback of the first video on the tablet is later than the

STB if the first video were also rendered on the STB. Regarding the transmission of the data of the second video, the streaming center of the STB and the streaming center of the tablet operate in a similar way because the second video is also a real time video. However, according to a variant, the second video is a file stored in a local storage. The control center 1011 determines whether or not there is a video version of the second video suitable for the TV to render, i.e. if the second video in the first format is available in the local storage. If yes, the streaming center of the tablet streams the second video in the first format to the STB. If not, the stream center of the tablet streams the second video in the second format to the STB, and the control center instructs the STB to trancode the second video from the second format to the first format. For the streaming in the direction from the tablet to the STB, the streaming process is asynchronous, i.e., if the network condition permits, the streaming process may be ahead of the rendering process because the file is stored at the STB.

Step 303, the STB renders the received data of the second video on the TV. Herein, if the format of received second video is the second format, it needs to convert the data of the second video from the second format to the first format before it renders on the TV.

According to a variant, the tablet has the functionality of format conversion. Upon the view switching instruction, the control center instructs the transcoder 1022 of the tablet to convert the second video from the second format to the first format. And in the above step 302, it's unnecessary for the transcoder of the STB to convert the second video from the second format to the first format.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations shall fall in the scope of the invention.

1. A method for view switching between a first device and a second device, wherein the first device and the second device are used to display respectively a first multimedia content and a second multimedia content that are correlated, it comprises, at the side of the first device, the steps of
receiving and displaying, by the first device, data of the first multimedia content;
in response to a view switching instruction, sending data of the first multimedia content to the second device and receiving data of the second multimedia content from the second device; and
displaying the received data of the second multimedia content.

2. The method of the claim 1, wherein the first multimedia content and the first multimedia content are organized respectively in a first format and a second format, which are suitable for the first device and the second device to display.

3. The method of the claim 2, wherein before sending the data of the first multimedia content, it further comprises the step of converting the first multimedia content from the first format to the second format.

4. The method of the claim 2, wherein the received second multimedia content is organized in the second format, and it further comprises the step of converting the second multimedia content from the second format to the first format after receiving the data of the second multimedia content,

5. The method of the claim 2, wherein the received second multimedia content is organized in the first format, which is converted by the second device from the second format to the first format.

6. The method of the claim 2, wherein at least two version with different formats of the second multimedia content are stored in a local storage, wherein, in response to the view switching instruction, one version with a format suitable for the first device to display is searched, and sent if existent to the first device.

7. The method of the claim 6, wherein, if one version with a format suitable for the first device to display is not existent, the current version used by the second device is converted to the first format and sent to the first device.

8. A first device for viewing change between it and a second device, wherein the first device and the second device are used to display a first multimedia content and a second multimedia content, it comprises
a streaming center configured to send and receive data; and
a transcoder configured to decode the data of the first multimedia content for displaying,
wherein, in response to a view switching instruction, the transcoder provides the data of the first multimedia content to the streaming center to send to the second device and receives data of the second multimedia content via the streaming center from the second device.

9. The device of the claim 8, wherein the transcoder is further configured to convert the content from one format to another.

10. The device of the claim 9, wherein before providing the data of the first multimedia content to the streaming center, the transcoder converts the first multimedia content from a first format, which is the format in which the first multimedia content is received by the transcoder, to a second format that is suitable for the second device to display.

11. The device of the claim 9, wherein the received data of the second multimedia content is organized in a second format, and after receiving the data of the second multimedia content the transcoder converts the second multimedia content from the second format to a first format that is suitable for the first device to display.
